(19) United States
(12) Patent Application Publication
(10) Pub. No.: US 2026/0361380 A1
(43) Pub. Date: Nov. 12, 2026

(54) PERFORMANCE MONITORING FOR AI/ML-BASED BEAM MANAGEMENT

(71) Applicant: Apple Inc., Cupertino, CA (US)

(72) Inventors: Weidong Yang, San Diego, CA (US); Chunxuan Ye, San Diego, CA (US); Huaning Niu, San Jose, CA (US); Peng Cheng, Beijing (CN); Wanshi Chen, San Diego, CA (US); Wei Zeng, Saratoga, CA (US)

(21) Appl. No.: 19/671,171

(22) Filed: May 7, 2026

Related U.S. Application Data
(60) Provisional application No. 63/803,448, filed on May 9, 2025.

(51) Int. Cl. H04B 7/06; H04W 24/10

(52) U.S. Cl. CPC H04B 7/06952; H04W 24/10

(57) ABSTRACT

Disclosed are methods, systems, and computer-readable medium to perform operations including: performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

### CROSS-REFERENCE TO RELATED APPLICATIONS

This application claims priority to and the benefit of U.S. Provisional Patent Application No. 63/803,448, filed May 9, 2025, the entire contents of which are incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the European Telecommunications Standards Institute (ETSI) Third Generation Partnership Project (3GPP). The wireless communication networks facilitate mobile broadband service using technologies such as orthogonal frequency-division multiple access (OFDMA), multiple-input multiple output (MIMO), advanced channel coding, massive MIMO, beamforming, and/or other features.

### SUMMARY

In an aspect, systems and process for user equipment (UE)-assisted performance monitoring for time-domain downlink beam prediction are configured for operations including performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

In some implementations, identifying the valid set of ground truth measurements for the second set of beams within the one or more second time instances includes determining whether all ground truth measurements in a particular set of ground truth measurements are performed and, based on determining that all ground truth measurements in the particular set of ground truth measurements are performed, determining that the particular set of ground truth measurements is valid.

In some implementations, determining whether to use the set of ground truth measurements to calculate the value of the performance metric includes determining whether the first time difference satisfies a first threshold value, in response to determining that the first time difference satisfies the first threshold value, calculating the value of the performance metric based on the set of ground truth measurements and including at least one ground truth measurement of the set for the report.

In some implementations, determining whether to use the set of ground truth measurements to calculate the value of the performance metric includes determining whether the second time difference satisfies a second threshold value, in response to determining that the second time difference satisfies the second threshold value, calculating the value of the performance metric based on the set of ground truth measurements and including at least one ground truth measurement of the set for the report. In some implementations, the second threshold value is determined based on a capability of a user equipment (UE).

In some implementations, the operations further include identifying a first configuration of a first periodic channel state information (CSI) report associated with performing the beam prediction, identifying a second configuration of a second periodic CSI report associated with monitoring the performance of the beam prediction, determining the first time instance based on the first configuration, and determining the reference time based on the second configuration. The second periodic CSI report includes the report. In some implementations, the first configuration includes (i) first resource set information associated with the one or more measurements and (ii) a periodicity and an offset of the first periodic CSI report. In some implementations, the second configuration includes (i) second resource set information associated with the set of ground truth measurements, (ii) a periodicity and an offset of the second periodic CSI report, and (iii) a threshold value associated with the first time difference.

In some implementations, the reference time is determined by one of a start time, an end time, or a median time of a duration of the one or more second time instances.

In some implementations, determining whether to use the set of ground truth measurements to calculate the value of the performance metric includes determining whether the first time difference is smaller than a time difference between a second reference time of another set of ground truth measurements and the first time instance and, in response to determining that the first time difference is smaller than the second time difference, calculating the performance metric based on the set of ground truth measurements.

In some implementations, determining whether to use the set of ground truth measurements to calculate the value of the performance metric includes determining whether the reference time is earlier than a second reference time of another set of ground truth measurements and, in response to determining that the reference time is earlier than the second reference time, calculating the performance metric based on the set of ground truth measurements.

In some implementations, determining whether to use the set of ground truth measurements to calculate the value of the performance metric includes determining whether the reference time is later than a second reference time of another set of ground truth measurements and, in response to determining that the reference time is later than the second reference time, calculating the performance metric based on the set of ground truth measurements.

In some implementations, the performance metric is calculated based on a plurality of sets of ground truth measurements. The plurality of sets of ground truth measurements includes the set of ground truth measurements.

In some implementations, identifying the set of ground truth measurements for the second set of beams within the reference time includes determining whether the set of ground truth measurements is valid.

In some implementations, determining whether the set of ground truth measurements is valid includes determining whether all ground truth measurements in the set of ground truth measurements are performed and, in response to determining that all ground truth measurements in the set of ground truth measurements are performed, determining that the set of ground truth measurements is valid.

In some implementations, determining whether the set of ground truth measurements is valid includes determining whether at least one ground truth measurement in the set of ground truth measurements is not performed and, in response to determining that the at least one ground truth measurement in the set of ground truth measurements is not performed, determining that the set of ground truth measurements is not valid.

In some implementations, determining whether the set of ground truth measurements is valid includes, for the set of ground truth measurements to be linked to a particular time instance, determining whether a beam inference report associated with the particular time instance is generated, in response to determining that the beam inference report is not generated, determining that the particular time instance is not valid, and, in response to determining that the particular time instance is not valid, determining that the set of ground truth measurements is not valid.

In another aspect, an apparatus including memory and one or more processors coupled to the memory and configured to, when executing instructions stored in the memory, cause the apparatus to perform operations, the operations including: performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

In some implementations, determining whether to use the set of ground truth measurements to calculate the value of the performance metric includes determining whether the first time difference satisfies a first threshold value, in response to determining that the first time difference satisfies the first threshold value, calculating the value of the performance metric based on the set of ground truth measurements and including at least one ground truth measurement of the set for the report.

In some implementations, determining whether to use the set of ground truth measurements to calculate the value of the performance metric includes determining whether the second time difference satisfies a second threshold value, in response to determining that the second time difference satisfies the second threshold value, calculating the value of the performance metric based on the set of ground truth measurements and including at least one ground truth measurement of the set for the report.

In another aspect, a baseband processor configured to, when executing instructions stored in a memory, perform operations, the operations including: performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

In another aspect, one or more processors are configured to, when executing instructions stored in memory, perform any of the foregoing operations.

In another aspect, a non-transitory computer storage medium is encoded with instructions that, when executed by one or more processors, cause the one or more processors to perform any of the foregoing operations.

In another aspect, a system comprises one or more processors and one or more storage devices on which are stored instructions that are operable, when executed by the one or more processors, to cause the one or more processors to perform any of the foregoing operations.

In an aspect, an apparatus comprises one or more baseband processors configured to perform any of the foregoing operations.

The details of one or more embodiments of the present disclosure are set forth in the accompanying drawings and the description below. Other features, objects, and advantages will be apparent from the description and drawings, and from the claims.

### BRIEF DESCRIPTION OF THE FIGURES

FIG. 1 illustrates an example wireless network, according to some implementations.

FIG. 2A is a diagram that illustrates an example of spatial-domain downlink beam prediction, according to some implementations.

FIG. 2B is a diagram that illustrates an example of time-domain downlink beam prediction, according to some implementations.

FIG. 3A illustrates an example process of artificial intelligence and machine learning (AI/ML)-based downlink beam management based on beam prediction at a base station, according to some implementations.

FIG. 3B illustrates an example process of AI/ML-based downlink beam management based on beam prediction at a user equipment (UE), according to some implementations.

FIG. 4 illustrates an example process of periodic channel state information (CSI) reporting, according to some implementations.

FIG. 5 is a diagram that illustrates an example of performance monitoring for AI/ML-based beam management, according to some implementations.

FIG. 6 is a diagram that illustrates an example of UE-assisted performance monitoring for time-domain downlink beam prediction, according to some implementations.

FIG. 7 is a flowchart that illustrates an example method for UE-assisted performance monitoring for time-domain downlink beam prediction, according to some implementations.

FIG. 8 is a flowchart that illustrates an example method for UE-assisted performance monitoring for time-domain downlink beam prediction, according to some implementations.

FIG. 9 illustrates an example of a UE, according to some implementations.

FIG. 10 illustrates an example access node, according to some implementations.

### DETAILED DESCRIPTION

Wireless communication networks can support multi-beam operation and beamforming techniques to achieve a higher data rate. In such a system, beam management can facilitate alignment of a pair of transmit and receive beams. For example, during a downlink beam management procedure, a user equipment (UE) measures a reference signal (e.g., SSB, CSI-RS) associated with transmit beams from a base station and selects a suitable receive beam that is best aligned with the transmit beam. To enhance this beam management functionality, artificial intelligence and machine learning (AI/ML) models and techniques can be used for beam prediction, including predictions in the spatial domain or the time domain. Spatial-domain downlink beam prediction (e.g., referred to as BM-Case 1) uses measurements of a configured set of downlink beams (e.g., denoted as Set B) to predict the best beam within another set of downlink beams (e.g., denoted as Set A) at present. Time-domain downlink beam prediction (e.g., referred to as BM-Case 2) uses measurements of Set B to predict the best beam within Set A on future prediction instances.

The inference performance of the AI/ML model affects the accuracy of the beam selection during beam management. Performance monitoring can ensure proper beam management operation of such a model. Performance monitoring may be performed at a network (e.g., base station) and/or assisted by the UE. For example, for UE-assisted performance monitoring, the UE calculates and reports to the network a performance metric (e.g., beam prediction accuracy). Based on the reported performance metric, the network can make a decision on the use of the AI/ML model, such as either to continue using the AI/ML model or to switch back to the legacy beam management operation. The performance metric of an inference result inferred from measurements of Set B may be calculated based on ground truth measurements of Set A, which are linked with the inference result. As such, it may be desirable to properly link the inference result with the ground truth measurements to calculate an accurate performance metric.

In some cases, the UE may experience issues in linking the inference result with ground truth measurements. This can occur due to one or more of network scheduling constraints, measurement gaps, a time division duplex uplink/downlink (TDD UL/DL) configuration, or other system configurations. In such a case, the UE may not be able to perform measurements of Set B from which an inference result needs to be inferred, or ground truth measurements that can be linked with the inference result most properly. As a result, the timing gap between an inference result and ground truth measurements to be linked with the inference result may not be suitable for performance monitoring.

The present disclosure provides techniques to enable performance monitoring of AL/ML models for use in beam management. In particular, the system and techniques described herein specify how to determine the validity of a group of ground truth measurements for a UE for beam management. In addition, techniques are described for determining a linking pair of a group of ground truth measurements among valid groups of ground truth measurements and an inference result (e.g., a prediction instance) for calculating a performance metric. In this manner, a UE can determine an accurate performance metric and report it to the network, thereby facilitating a precise decision by the network on the use of the AI/ML model and ensuring proper beam management operation.

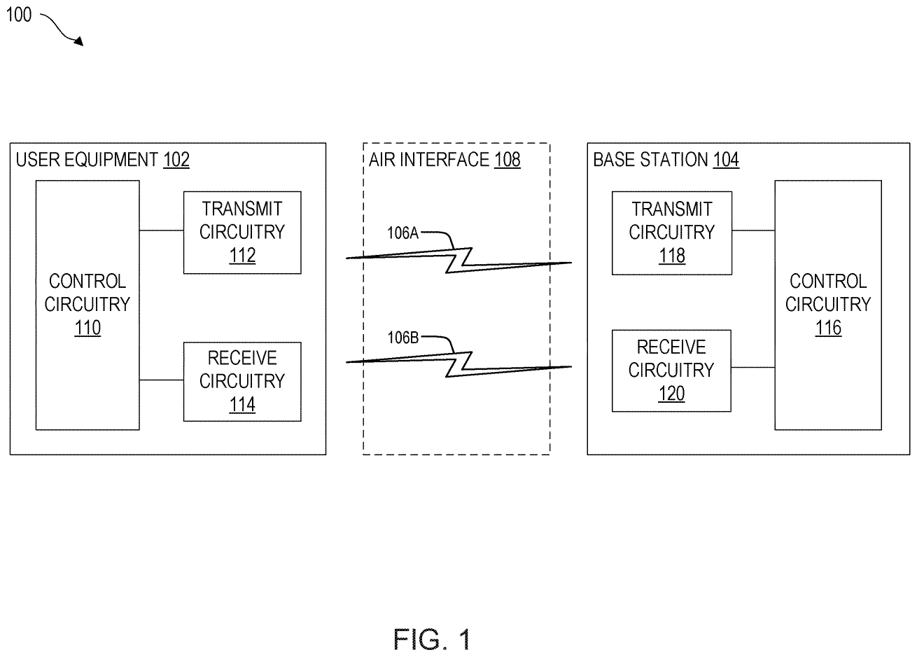

FIG. 1 illustrates an example wireless network 100, according to some implementations. The wireless network 100 includes a UE 102 and a base station 104, which are connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates fifth generation (5G) New Radio (NR). In some other implementations, the wireless network 100 is a non-standalone (NSA) network that incorporates Long Term Evolution (LTE) and 5G NR. In these implementations, the wireless network 100 may be an Evolved Universal Terrestrial Radio Access (E-UTRA) NR dual connectivity (EN-DC) network, or an NR-EUTRA dual connectivity (NE-DC) network. Furthermore, wireless networks implementing one or more other types of communication standards are possible, including future 3GPP systems (e.g., sixth generation “6G”), Institute of Electrical and Electronics Engineers (IEEE) 902.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

The control circuitry 110 can perform various operations described herein. For example, the control circuitry 110 can determine an instance for a beam prediction inferred from beam measurements of a set of beams using AI/ML model, identify a valid set of ground truth measurements for a set of beams within one or more instances, and calculate a value of a performance metric representing a performance of the beam prediction of the instance for the beam prediction based on the set of valid ground truth measurements. The transmit circuitry 112 can perform various operations described in this specification. For example, the transmit circuitry 112 can transmit a report indicating a value of the performance metric.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can determine a measurement period for UE-initiated/event-driven beam measurement reporting based on a periodicity of reference signals associated with a first/second beam, a number of samples used for measurements of the first/second beam, and so on.

The transmit circuitry 112 can perform various operations described herein. For example, the transmit circuitry 112 can transmit a PUCCH to request uplink resources for a UE-initiated/event-driven beam measurement report. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation (CA). The transmit circuitry 112 may be configured to receive block data from the control circuitry 110 for transmission on the air interface 108.

The receive circuitry 114 can perform various operations described herein. For example, the receive circuitry 114 can receive one or more reference signals (such as an SSB) via a first beam and a second beam during a measurement period that depends on a reference signal periodicity of the first beam and/or the second beam. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with CA. The transmit circuitry 112 and the receive circuitry 114 may transmit and receive, respectively, both control data and content data (e.g., messages, images, video, and the like) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink interface and may include one or more logical channels, including but not limited to a physical sidelink control channel (PSCCH), a physical sidelink discovery channel (PSDCH), and a physical sidelink broadcast channel (PSBCH).

The UE 102 and the base station 104 are configured to perform operations assisted based on AI/ML models for wireless communication. For example, AI/ML models and AI/ML techniques may be used for channel state information (CSI) feedback, beam management, and/or positioning. The AI/ML techniques may also enable network automation or data collection for various network functions. Furthermore, the AI/ML techniques may support AI/ML-based network energy savings, load balancing, and mobility optimization.

The AI/ML model may be defined as a data-driven algorithm that applies AI/ML techniques to generate a set of outputs based on a set of inputs. The AI/ML model may be implemented at the UE side, the network side, or both. Generally, stages of AI/ML-related algorithms and associated complexity may be characterized by model generation and inference operation (e.g., input/output, pre-/post-process). The model generation may include model training (e.g., input/output, pre-/post-process, online/offline), model validation, and model testing. The life cycle management (LCM) of AI/Model and AI/ML functionality may be implemented for various aspects, which include, for example, data collection, model training, functionality/model identification, model delivery/transfer, model inference operation, functionality/model selection, activation, deactivation, switching and fallback operation, functionality/model monitoring, model update, and UE capability.

For AI/ML-based beam management, various AI/ML techniques, such as at least model training, model inference, and model monitoring, may be used. For AI/ML model training, the UE or the base station may generate training data. The AI/ML model training described herein is a process to train an AI/ML model in a data-driven manner and obtain the trained AI/ML model for inference of network conditions in the future. The AI/ML model inference described herein includes a process of using the trained AI/ML model to produce a set of outputs based on a set of inputs. For network-side AI/ML model inference, the UE may generate input data and transmit the generated input data to the base station. For UE-side AI/ML model inference, input data may be internally available at the UE. In order to evaluate the inference performance of the AI/ML model, AI/ML model monitoring (e.g., performance monitoring) may be performed.

Performance monitoring for an AI/ML model ensures that the model provides accurate inferences or predictions. Among various types of performance monitoring, Type 1 can be supported for both BM-Case 1 and BM-Case 2. For Type 1 performance monitoring, the UE may be configured or signaled from a network, such as the base station, for measurement and/or reporting. The UE may support two options of Type 1 performance monitoring: Option 1 is network-side performance monitoring, and Option 2 is UE-assisted performance monitoring. During Type1/Option1 network-side performance monitoring, the UE may transmit a monitoring result report to the network (e.g., for the calculation of a performance metric at the network). The monitoring result report may include measurement results from resource sets for performance monitoring (e.g., L1-RSRP and/or RS index) and any other contents. During Type1/Option2 performance monitoring, the UE may calculate one or more performance metrics and report them or associated information to the network. Performance metrics described herein can be at least one of a beam prediction accuracy (e.g., Top-K/1 beam prediction accuracy), a link quality (e.g., throughput, L1-RSRP, L1-SINR, hypothetical BLER), a metric based on input/output data distribution of AI/ML, or a difference between measured reference signal received power (RSRP) and predicted RSRP.

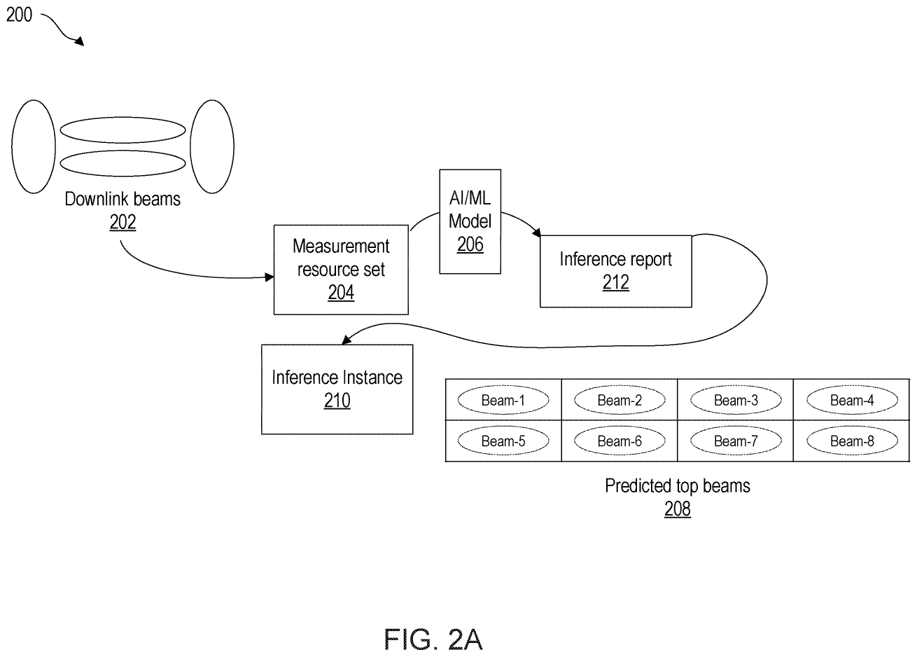

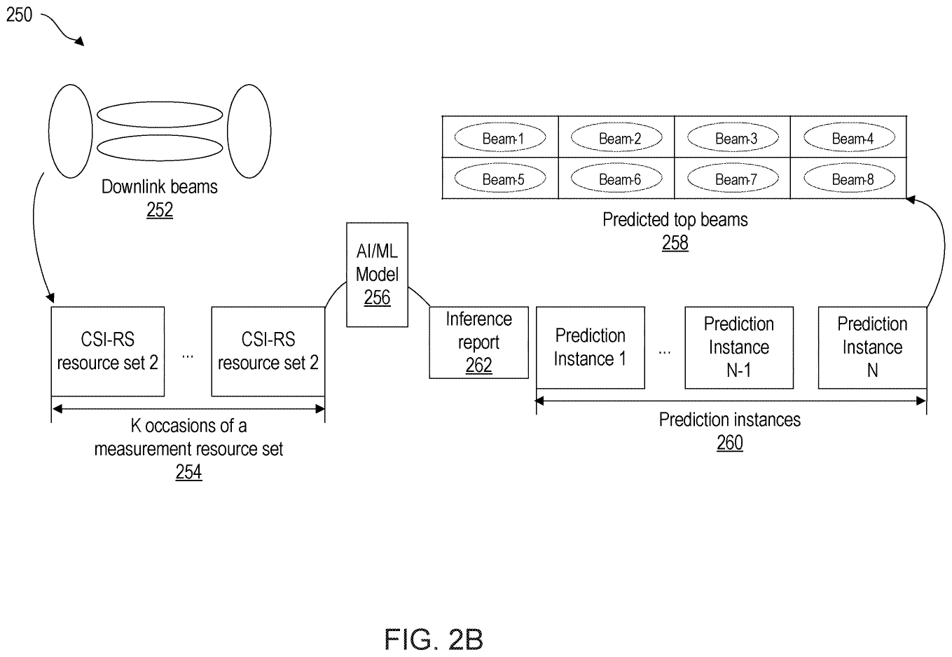

FIG. 2A illustrates an example diagram 200 of spatial-domain downlink beam prediction, according to some implementations. Spatial-domain downlink beam prediction may be performed at a UE (e.g., UE 102) or a base station (e.g., base station 104) based on measurement results of Set B of beams to predict the best beams within Set A of beams. The UE performs measurements of downlink beams 202 (e.g., Set B) on measurement resource set 204 (e.g., SSB, CSI-RS resource set) configured by the base station. Using the AI/ML model 206, the top beams 208, Beam-1 through Beam-8, may be inferred at present at the inference instance 210 based on the measurement result of downlink beams 202. The inference report 212 may include information, such as a beam index and an L1-RSRP, of the predicted top beams 208 for the inference instance 210.

FIG. 2B illustrates an example diagram 250 of time-domain downlink beam prediction, according to some implementations. Time-domain (or temporal) downlink beam prediction may be performed at a UE (e.g., UE 102) or a base station (e.g., base station 104) based on measurement results of Set B of beams to predict the best beam within Set A of beams for future time instants. The UE performs measurements for downlink beams 252 (e.g., Set B) on each of K occasions of measurement resource set 254 (e.g., SSB, CSI-RS resource set) configured by the base station. Using the AI/ML model 256, the top beams 258 can be predicted for the future in each of N prediction instances 260 based on the measurement results of downlink beams 252. As such, the inference report 262 may include information, such as a beam index and an L1-RSRP, on the predicted top beams 258 for N prediction instances 260.

In some implementations, in BM-Case 2 for UE-side (e.g., UE-assisted) model, a time gap between two consecutive prediction instances among the N prediction instances 260 may be configured as one of 10 ms, 20 ms, 40 ms, 80 ms, and 160 ms. The number of prediction instances 260 (e.g., N) may be configured as one of 1, 2, 4, or 8. The time gap between two consecutive prediction instances and the number of prediction instances may be configured for the UE by radio resource control (RRC) signaling. A reference time of the earliest prediction instance among the N prediction instances 260 may be determined based on the most recent occasion of a measurement resource set 254. The most recent occasion may be the latest CSI-RS/SSB occasion, which is no later than the corresponding CSI reference resource of the corresponding inference report 262.

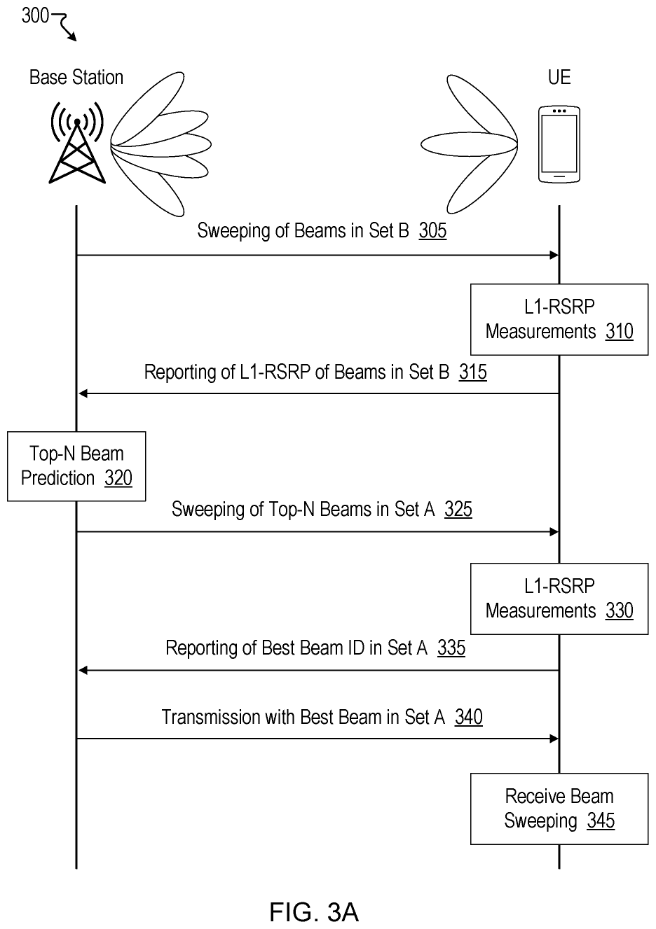

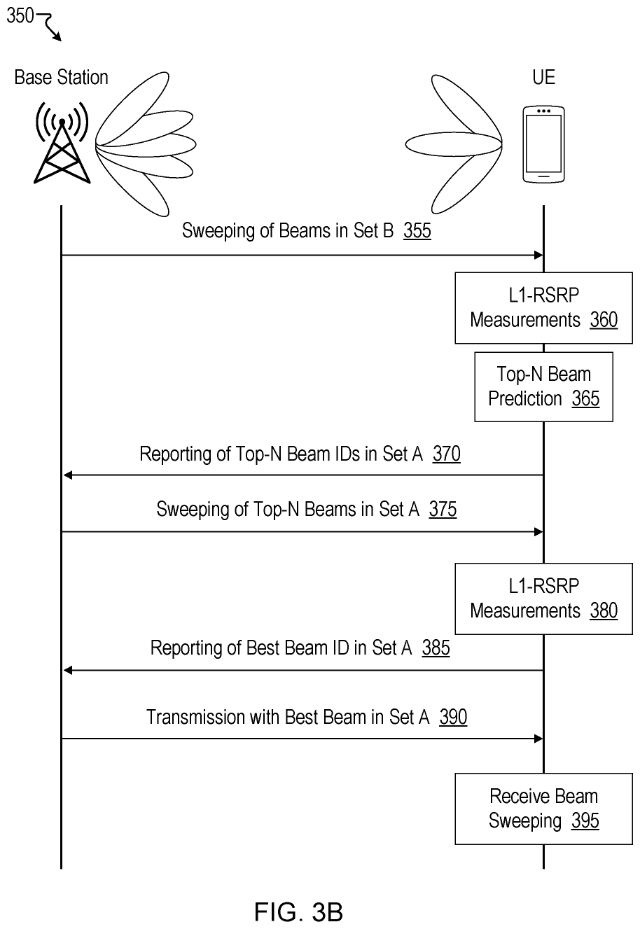

FIG. 3A illustrates an example process 300 of AI/ML-based downlink beam management based on beam prediction at a base station, according to some implementations. A UE (e.g., UE 102) and the base station (e.g., base station 104) perform a beam management process based on a beam prediction at the base station. At step 305, the base station sweeps through transmit beams in Set B to collect data. At step 310, the UE performs L1-RSRP measurements of the transmit beams in Set B. At step 315, the UE reports the L1-RSRP measurement of the transmit beams in Set B to the base station. At step 320, the base station performs beam prediction using an AI/ML model to predict top-N transmit beams in Set A. At step 325, the base station sweeps through the top-N transmit beams in Set A. At step 330, the UE performs L1-RSRP measurements of the top-N transmit beams in Set A to identify the best beam. At step 335, the UE reports the identity (ID) of the best transmit beam in Set A to the base station. At step 340, the base station transmits with the best beam in Set A. At step 345, the UE sweeps through different receive beams to find the best receive beam that pairs with the selected transmit beam.

FIG. 3B illustrates an example process 350 of AI/ML-based downlink beam management based on beam prediction at a UE, according to some implementations. A UE (e.g., UE 102) and the base station (e.g., base station 104) perform a beam management process based on a beam prediction at the UE. At step 355, the base station sweeps through transmit beams in Set B to collect data. At step 360, the UE performs L1-RSRP measurements of the transmit beams in Set B. At step 365, the UE performs beam prediction using an AI/ML model to predict top-N transmit beams in Set A. At step 370, the UE reports the top-N transmit beams in Set A in an inference report. At step 375, the base station sweeps through the top-N transmit beams in Set A. At step 380, the UE performs L1-RSRP measurements of the top-N transmit beams in Set A to identify the best beam. At step 385, the UE reports the ID of the best transmit beam in Set A to the base station. At step 390, the base station transmits with the best beam in Set A. At step 395, the UE sweeps through different receive beams to find the best receive beam that pairs with the selected transmit beam.

The signaling overhead for the configuration of measurement resource sets may be considered reasonable, depending on the value of N. For example, if a value of N is set to 1, a network, such as a base station, can configure measurement resource sets for some or all beams in Set A, and each of the measurement resource sets comprises a single beam in Set A. In this example, the signaling overhead for the configuration may be relatively small. However, if a value of N is set to a larger number, for example, 4, and there are 32 beams in Set A, then the number of configuration combinations of measurement resource sets is 35960. For example, the configuration combinations may be as follows: measurement resource set 1={beams 1, 2, 3, 4}, measurement resource set 2={beams 1, 2, 3, 5}, and so on. Too large a number of configuration combinations may not be feasible to explicitly (pre) configure measurement resource sets. In some implementations, the network may refer to the CSI report configuration information (e.g., IE CSI-ReportConfigId) and additionally the CSI feedback timing information to uniquely identify the inference report sent by the UE at step 370. If CSI feedback timing information is not included, the UE may assume the inference report is transmitted in the latest instance of inference report, which is Z slots (or Z ms) ahead of network signaling (e.g., at step 375) or UE reporting (e.g., at step 385). The time gap (e.g., Z slots, Z ms) may allow the network enough processing time to parse the inference report. To provide network implementation flexibility, a value of Z may be set to zero.

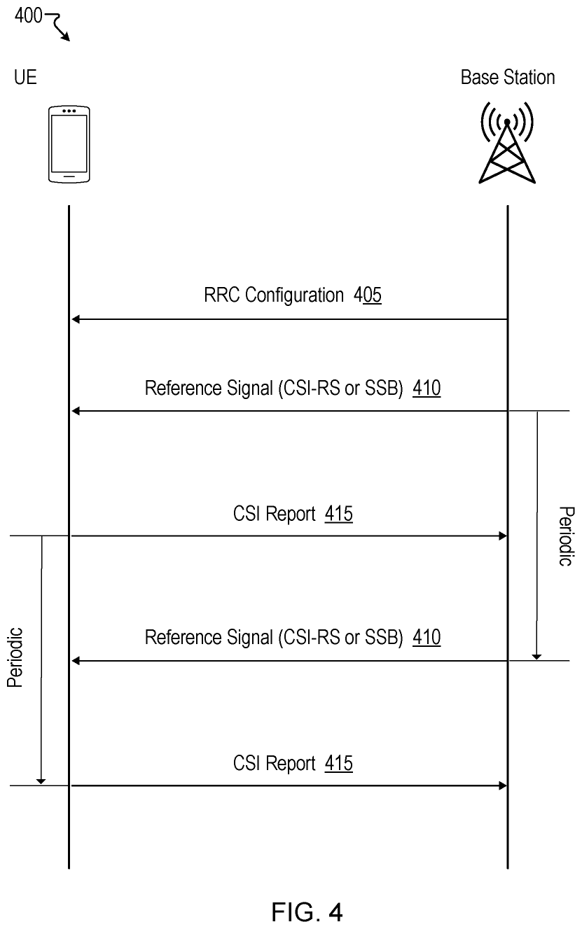

FIG. 4 illustrates an example process 400 of periodic CSI reporting, according to some implementations. A UE (e.g., UE 102) performs periodic CSI reporting to a base station (e.g., base station 104) according to the CSI framework. At step 405, the UE is configured with CSI measurement and reporting by a higher layer signaling, such as RRC signaling. The UE receives RRC configuration for periodic CSI reporting from the base station. The base station transmits the RRC configuration for periodic CSI reporting, which may include at least the information elements (IEs) CSI-ReportConfig, CSI-ResourceConfig, CSI-RS-ResourceSetList, CSI-RS-ResourceSet, and CSI-RS-Resource. The report setting IE CSI-ReportConfig configures a periodic report transmitted on PUCCH if a time domain behavior of reporting configuration is set to ‘periodic’ by the IE reportConfigType. The IE CSI-ReportConfig includes the IE reportSlotConfig that indicates a periodicity and a slot offset for the periodic CSI report, which are given by the IE CSI-ReportPeriodicityAndOffset. The IE CSI-ReportConfig indicates CSI resource settings, each identified by the IE CSI-ResourceConfigId. The resource setting IE CSI-ResourceConfig specifies a configuration of a list of CSI Resource Sets given by IE CSI-RS-ResourceSetList. The IE CSI-RS-Resource Set specifies a set of CSI-RS resources, each given by the IE CSI-RS-Resource. The IE CSI-RS-Resource (e.g., NZP-CSI-RS-Resource) includes the IE periodicityAndOffset that indicates a periodicity and a slot offset for a CSI-RS resource, which are given by the IE CSI-ResourcePeriodicityAndOffset.

At step 410, the UE receives a reference signal (e.g., CSI-RS) from the base station. The base station periodically transmits the reference signal on CSI-RS resources using the periodicity and the slot offset indicated by the IE CSI-ResourcePeriodicityAndOffset. At step 415, the UE measures the reference signal and periodically transmits CSI on a physical uplink control channel (PUCCH) using the periodicity and the slot offset indicated by the IE CSI-ReportPeriodicityAndOffset.

The existing CSI framework can be reused for performance monitoring (e.g., Type1/Option2). In some implementations, a dedicated CSI report configuration (e.g., given by IE CSI-ReportConfig) may be used to configure one or more dedicated resource sets for performance monitoring and a monitoring result report. As such, the UE may measure the dedicated resource sets for performance monitoring and transmit the monitoring result report. In some implementations, CSI reporting for performance monitoring may be configured separately from CSI reporting for inference. Unlike the self-contained CSI reporting specified in the existing CSI framework, the configuration for an inference report and the configuration for the monitoring result report may be linked. As such, an identity (ID) of the CSI report configuration for inference may be configured in a CSI report configuration for performance monitoring to link the configuration for the inference report and the configuration for the monitoring result report.

For example, the IE CSI-ReportConfig may be specified as:

CSI-ReportConfig {
// This is for performance monitoring
CSI-Report-ID // 2
linked-CSI-Report-ID // populated with value at ″1″
}
CSI-ReportConfig {
// This is for inference
CSI-Report-ID // 1
}

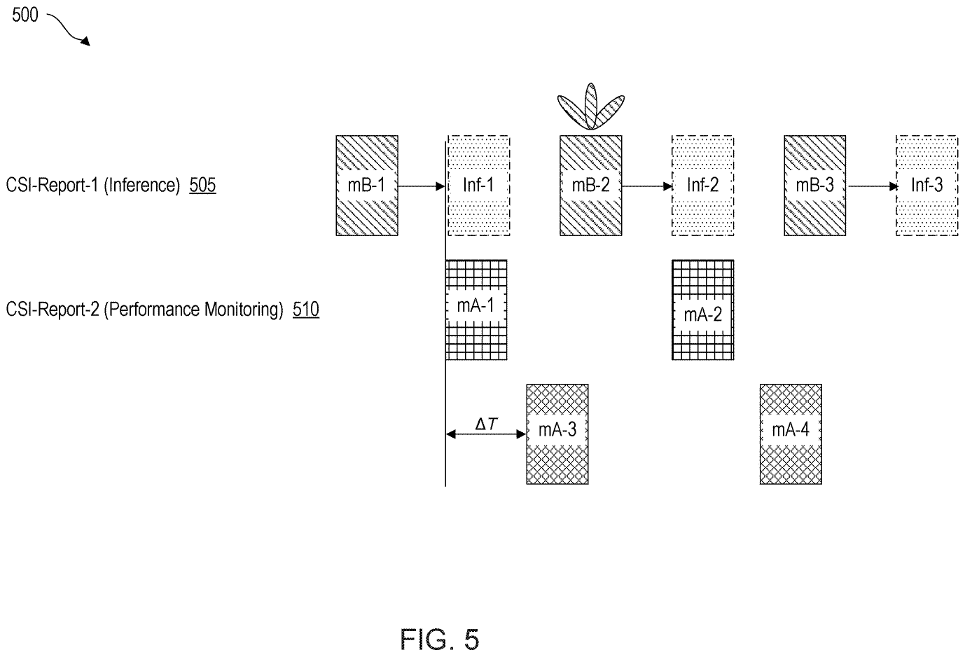

FIG. 5 illustrates an example diagram 500 of performance monitoring for AI/ML-based beam management, according to some implementations. As described above, CSI-Report-1 505 for inference and CSI-Report-2 510 for performance monitoring are separately configured. CSI-Report-2 510 for performance monitoring is linked with CSI-Report-1 for inference 505. CSI-Report-1 for inference 505 configures measurement resources for Set B of beams, mB-1 through mB-3. Inference results, Inf-1 through Inf-3, are inferred from measurements of Set B of beams on mB-1 through mB-3, respectively. CSI-Report-2 for performance monitoring 510 configures ground truth measurement resources for Set A of beams, mA-1 through mA-4. As shown in FIG. 5, mA-1 and mA-2 are aligned with Inf-1 and Inf-2 in the time domain, while mA-3 and mA-4 are separated from Inf-1 and Inf-2 in the time domain. In case of UE-assisted performance monitoring (e.g., Type1/Option 2), as a UE (e.g., UE 102) calculates a performance metric, the UE needs to properly correlate Inf-1 through Inf-3 with mA-1 through mA-4 to derive accurate performance metrics.

However, in some cases (as previously discussed), there may be issues in linking inference results with ground truth measurements. In particular, the UE may experience problems while performing measurements on recent occasions of measurement resources. In an example of Case 1, due to network scheduling, when a PDSCH is scheduled with a transmission configuration indicator (TCI) state different from the TCI states of Set B of beams, the UE may not be able to measure beams at mB-2. In an example of Case 2, due to a measurement gap during which receiving data on a downlink shared channel (DL-SCH) is suspended, the UE may not be able to measure beams at mB-2. In both Case 1 and Case 2, as mB-1 may be assumed to be CSI measurement resources for Inf-2, a valid inference report from mB-2 may not be generated. In an example of Case 3, due to a network scheduling issue, similar to Case 1, the UE may not be able to measure beams at mA-1. In an example of Case 4, due to a measurement gap, similar to Case 3, the UE may not be able to measure beams at mA-1. In both Case 3 and Case 4, ground truth measurements at mA-1 may be considered invalid. In an example of Case 5, due to the TDD UL/DL configuration or system configuration, the UE has to measure beams at mA-3 instead of mA-1. As the timing gap AT between Inf-1 and mA-3 may be substantial, the pair of Inf-1 and mA-3 may not be suitable for performance monitoring. The issues described in Cases 1 through 5 may lead the UE to a problem in calculating the performance metric.

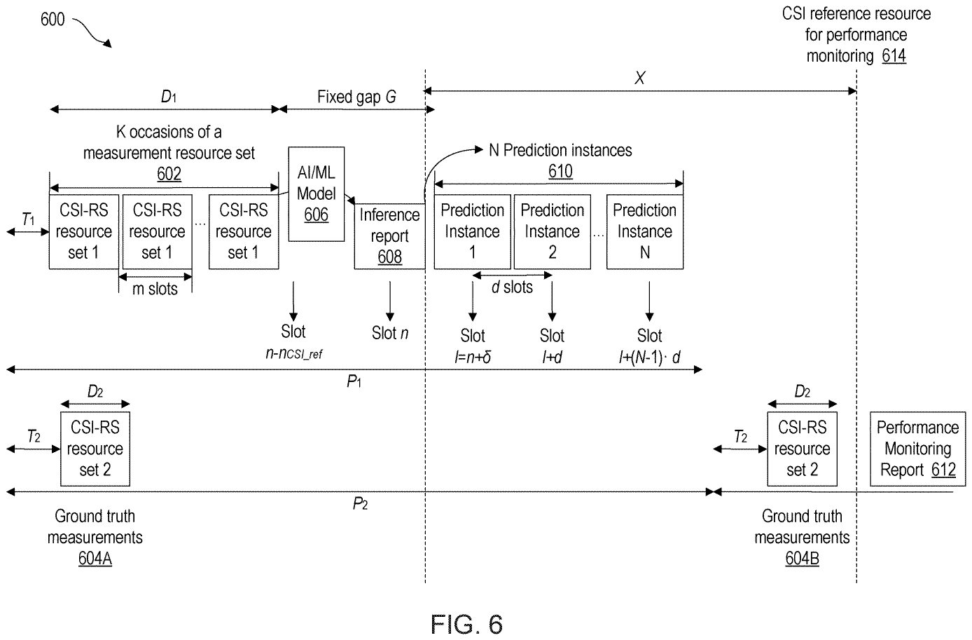

FIG. 6 illustrates an example diagram 600 of UE-assisted performance monitoring for time-domain downlink beam prediction, according to some implementations. In some implementations, a UE (e.g., UE 102) may be configured to report a performance metric (e.g., beam prediction accuracy) for at least one prediction instance by the IE CSI-ReportConfig for performance monitoring (e.g., CSI-Report-2 510). In such implementations, one resource set for groups of ground truth measurements 604A and 604B (e.g., CSI-RS resource set 2) and one prediction instance for performance metric calculation may be configured in CSI-ReportConfig. For example, the configured prediction instance may be one of the N prediction instances 610 in the inference report 608. The N prediction instances 610 may be inferred from measurements of Set B on K occasions of the measurement resource set 602 using the AI/ML model 606.

The UE may calculate the performance metric of the configured prediction instance based on transmission occasions of performance monitoring resources (e.g., a resource set for the group of ground truth measurements 604A or 604B of Set A). In such implementations, the transmission occasions of performance monitoring resources may be one or more latest transmission occasions that are linked with the configured prediction instance. The base station may configure the number of transmission occasions of performance monitoring resources in CSI-ReportConfig. The configured prediction instance may have a minimal offset (e.g., in slots) to at least one of the transmission occasions of performance monitoring resources. At least the inference report 608 associated with the configured prediction instance, the transmission occasions of performance monitoring resources, or the configured prediction instance may be no later than the CSI reference resource for performance monitoring 614.

In some implementations, a nominal minimal offset may be defined, as the offset between a prediction instance and at least one of transmission occasions of performance monitoring resource (e.g., a resource set for the group of ground truth measurements 604A or 604B of Set A) may be affected by the TDD UL/DL pattern or dynamic TDD signaling. For example, in case a prediction instance is in slot #100, and transmissions of a performance monitoring resources follow a periodicity of 50 slots, starting from slots #101, #151, #251, and so on, if slot #101 is a DL slot, then the minimal offset is 1. However, in the same case above, part of slot #101 is used for uplink transmission due to dynamic TDD signaling, and the next transmission occasion for performance monitoring resources starts from slot #151, the pairing of the prediction instance and the transmission occasion for performance monitoring resources may be considered erroneous. In some cases, the inference report 608 can be dropped, or a measurement of a reference signal for performance monitoring may not be conducted by the UE. In such a case, the minimal offset can be ambiguous. To avoid this ambiguousness, the nominal minimal offset may be defined as the smallest time gap between periodic/semi-persistent inference reports (e.g., inference report 608), which are assumed to be transmitted according to configurations.

In case a cell (or component carrier) where a PUCCH is transmitted (e.g., PUCCH cell) is configured as a TDD cell, the minimal slot offset may be determined in different ways. In some implementations, in case a TDD UL/UL pattern is considered for a transmission occasion of an inference report 608 and a transmission occasion of performance monitoring resources, the transmission occasion of inference report 608 overlapping with any DL symbol(s) may not be considered in deriving a minimal offset. In such a case, if any measurement resource in the transmission occasion of performance monitoring resource overlaps with any UL symbol(s), the transmission occasion of performance monitoring resources may not be considered in deriving the minimal offset. The IE tdd-UL-DL-ConfigurationCommon and/or tdd-UL-DL-ConfigurationDedicated configured for a PUCCH cell may be applied for the inference report 608. The IE tdd-UL-DL-ConfigurationCommon and/or tdd-UL-DL-ConfigurationDedicated for the cell where performance monitoring resources are configured may be applied to the performance monitoring resources.

In some implementations, a TDD UL/DL pattern may not be considered for an inference report 608 or a transmission occasion of performance monitoring resources. In such implementations, if a transmission occasion of the inference report 608 overlaps with a DL symbol, the transmission occasion of the inference report 608 may be considered in the derivation of a minimal offset. If the transmission occasion of performance monitoring resources has one or more performance monitoring resources overlapping with UL symbol(s), the transmission occasion of performance monitoring resources may be considered in the derivation of the minimal offset.

The UE can determine the validity of the ground truth measurements as now described. In some implementations, if the UE cannot perform at least one ground truth measurement among a group of ground truth measurements (e.g., group of ground truth measurements 604A or 604B), that group of ground truth measurements may not be considered valid. In Cases 3 and 4 described above, where the UE cannot perform a particular ground truth measurement of Set A on a transmission occasion of performance monitoring resources due to network scheduling or a measurement gap, the group of ground truth measurements that includes the particular ground truth measurement is not considered valid. In such implementations, the UE may determine whether all ground truth measurements in the group of ground truth measurements are performed. If the UE determines that all ground truth measurements in the group of ground truth measurements have been performed, the UE may determine that the group of ground truth measurements is valid. If the UE determines that at least one ground truth measurement included in the group of ground truth measurements has been performed, the UE may determine that the group of ground truth measurements is not valid.

In some implementations, if an inference report (e.g., inference report 208) that is linked with transmission occasions of performance monitoring resources is not generated, a group of ground truth measurements on the transmission occasions linked with the inference report may not be considered valid. In Cases 1 and 2 described above, where the UE cannot perform a particular measurement of Set B due to network scheduling or a measurement gap, the inference report may include a prediction instance for the particular measurement cannot be generated. In such a case, a ground truth measurement linked with the inference report may not be considered valid. In such implementations, the UE may determine whether an inference report is generated for the configured prediction instance. If the UE determines that the inference report is not generated for the prediction instance, the UE may determine that the prediction instance and the group of ground truth measurements linked to the inference report are not valid.

The UE or the network can determine a linking pair of a group of ground truth measurements and a prediction instance for calculating a performance metric. In some implementations, the UE may determine a group of ground truth measurements to be linked with a prediction instance among valid groups of ground truth measurements. For example, if there are two valid groups of ground truth measurements (e.g., ground truth measurements 604A and 604B), the UE may determine which group is used for calculating the performance metric for the prediction instance.

In some implementations, the UE may select one group of ground truth measurements that is nearer to the prediction instance between the two groups of ground truth measurements. In such implementations, the UE may determine whether the timing gap between the timing of one group of ground truth measurements and the timing of the prediction instance is smaller than the timing gap between the timing of another group of ground truth measurements and the timing of the prediction instance. If the UE determines that the timing gap between the timing of one group of ground truth measurements and the timing of the prediction instance is smaller, the UE may determine the group of ground truth measurements with the smaller timing gap as being linked with the prediction instance.

In some implementations, the UE may select an earlier group of ground truth measurements between the two groups of ground truth measurements to avoid non-causal processing. In such implementations, the UE may determine whether the timing of one group of ground truth measurements (e.g., ground truth measurements 604A) is earlier than the timing of another group of ground truth measurements (e.g., ground truth measurements 604B). If the UE determines that the timing of one group of ground truth measurements is earlier than the timing of another group of ground truth measurements, the UE may determine the earlier group of ground truth measurements as being linked with the prediction instance.

In some implementations, the UE may select a later group of ground truth measurements between the two groups of ground truth measurements to reflect a more relevant situation. In such implementations, the UE may determine whether the timing of one group of ground truth measurements (e.g., ground truth measurements 604B) is later than the timing of another group of ground truth measurements (e.g., ground truth measurements 604A). If the UE determines that the timing of one group of ground truth measurements is later than the timing of another group of ground truth measurements, the UE may determine that the later group of ground truth measurements are being linked with the prediction instance.

In some implementations, the UE may identify at least a periodicity P₁, an offset T₁, a duration D₁, or the timing of the configured prediction instance using the information configured in the CSI report configuration for inference (e.g., CSI-Report-1 505 of FIG. 5). In such implementations, the base station may configure the periodicity P₁ and the offset T₁ in the IE CSI-ReportPeriodicityAndOffset in CSI-ReportConfig. The UE may derive the duration D₁ from the timing of the earliest measurement resource and the timing of the latest measurement resource in set B. The duration D₁ may correspond to the distance between the start time and the end time of K occasions of a measurement resource set 602. The UE may determine the timing of the prediction instance as: q₁P₁+T₁+D₁+G+N·d, where q₁=0, 1, 2, . . . , N is the number of prediction instances, and d is a time domain size of one prediction instance.

In some implementations, the UE may identify at least a periodicity P₂, an offset T₂, a duration D₂, or the reference timing of a group of ground truth measurements using the information configured in the CSI report configuration for performance monitoring (e.g., CSI-Report-2 510 of FIG. 5). In such implementations, the base station may configure the periodicity P₂ and the offset T₂ in the IE CSI-ReportPeriodicityAndOffset in CSI-ReportConfig. The UE may derive the duration D₂ from the timing of the earliest ground truth measurement resource and the timing of the latest ground truth measurement resource in set A. The duration D₂ may correspond to the distance between the start time and the end time of one or more transmission occasions of the resource set for the group of ground truth measurements. As Set A of beams spans a long duration (e.g., large D₂), the reference timing of the group of ground truth measurements may be alternatively defined by the start time, the median time (e.g., T_2+D_2/2), or the end time (e.g., T₂+D₂) of one or more transmission occasions of the resource set for the group of ground truth measurements. Assuming the reference timing of the group of ground truth measurements is defined by the median time, the UE may determine the reference timing of the group of ground truth measurements as

$${q}_{2} {P}_{2} + {T}_{2} + \frac{{D}_{2}}{2} .$$

In some implementations, the UE may identify a threshold value, for example, k (e.g., in slots) between the timing of a group of ground truth measurements and the timing of a prediction instance. The threshold value k may depend on the value of N, which is the number of prediction instances. Additionally, the UE may identify another threshold value, for example, X, between the timing of an inference report and the timing of the group of ground truth measurements. As X essentially determines a sliding window outside which the UE does not need to remember an inference report, the threshold value X may depend on the capability of a UE on the supported X values. For example, if the UE has more memory, it can remember more inference reports, the threshold value X can be large for that UE. Both threshold values k and X are used to avoid an inaccurate calculation of a performance metric due to a substantial timing gap caused by a change in channel conditions or UE mobility.

In some implementations, the UE may identify a valid CSI instance for an inference report and its timing (e.g., slot n) and a valid group of ground truth measurements that is nearest to the valid CSI instance for the inference report and its timing. If the timing gap between the timing of the valid CSI instance for the inference report and the timing of the nearest valid group of ground truth measurements is below a threshold value X, one sample may be logged for the valid CSI instance for the inference report. In such implementations, the UE may determine whether the timing gap between the timing of the valid CSI instance for the inference report and the timing of the nearest valid group of ground truth measurements satisfies the threshold value X. If the UE determines that the timing gap satisfies the threshold value X, the UE may log the sample for the valid CSI instance for the inference report.

In some implementations, the UE may identify a valid group of ground truth measurements and its timing, and a prediction instance that is nearest to the valid group of ground truth measurements and its timing. Alternatively, the UE may identify a valid group of ground truth measurements and its timing, and a prediction instance that is earlier than other prediction instances and its timing. If the timing gap between the timing of the group of ground truth measurements and the timing of the nearest or earlier prediction instance is below a threshold value k, one sample may be logged for the valid CSI instance for the inference report. In such implementations, the UE may determine whether the timing gap between the timing of the group of ground truth measurements and the timing of the prediction instance nearest to the valid group of ground truth measurements satisfies the threshold value k. Alternatively, the UE may determine whether the timing gap between the timing of the group of ground truth measurements and the timing of the prediction instance that is earlier than other prediction instances satisfies the threshold value k. If the UE determines that the timing gap satisfies the threshold value k, the UE may log the sample for a valid CSI instance for the inference report (e.g., slot n).

In some implementations, the UE may identify a prediction instance and one or more actual beam transmissions that are nearest to the prediction instance. The actual beam transmissions may correspond to transmission occasions for one or more groups of ground truth measurements. For example, in case the UE identifies a prediction instance and two top beams, transmit (Tx) beam-1 and Tx beam-18, are inferred for the prediction instance, the pair-1 of the prediction instance and the Tx beam-1 and the pair-2 of the prediction instance and the Tx beam-18 may point to different groups ground truth measurements. In this scenario, the prediction instance may be linked with the later group of ground truth measurements (e.g., ground truth measurements 604B) for the Tx-1 beam and linked with the earlier group of ground truth measurements (e.g., ground truth measurements 604A) for the Tx-beam 18. In such implementations, the UE may identify transmission occasions for one or more groups of ground truth measurements that correspond to one or more top beams predicted for the prediction instance. The UE may determine which transmission occasion among identified transmission occasions is nearest to the prediction instance for each predicted top beam. If the UE determines the nearest transmission occasion for each predicted top beam, the UE may determine a group of ground truth measurements corresponding to the nearest transmission occasion to link with the prediction instance.

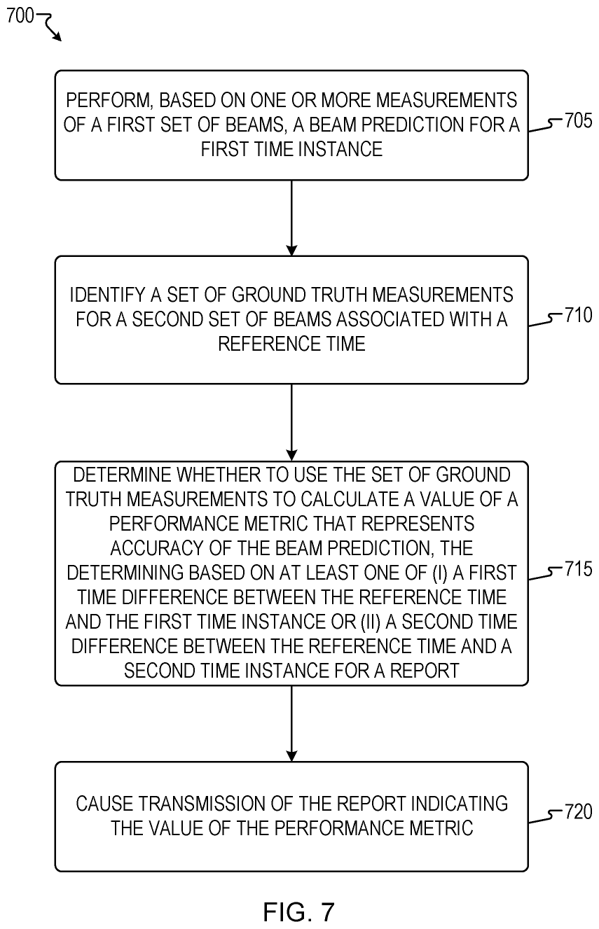

FIG. 7 illustrates a flowchart of an example method 700 for UE-assisted performance monitoring for time-domain downlink beam prediction, according to some implementations. For clarity of presentation, the example method 700 is described in the context of the preceding figures. For clarity of presentation, the example method 700 is described in the context of the preceding figures. For example, the method 700 can be performed by a UE (e.g., the UE 102), or any suitable system, environment, software, hardware, or combination thereof. In some implementations, operations of the method 700 can be run in parallel, in combination, in loops, or in any order. The example method 700 shown in FIG. 7 can be modified or reconfigured to include additional, fewer, or different steps (not shown in FIG. 7), which can be performed in the order shown or in a different order.

Operations of the method 700 include, at 705, performing, based on one or more measurements of a first set of beams, a beam prediction for a first time instance.

Operations of the method 700 include, at 710, identifying a set of ground truth measurements for a second set of beams associated with a reference time.

Operations of the method 700 include, at 715, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report.

Operations of the method 700 include, at 720, causing transmission of the report indicating the value of the performance metric.

In some implementations, determining whether to use the set of ground truth measurements to calculate the value of the performance metric may include determining whether the first time difference satisfies a first threshold value, in response to determining that the first time difference satisfies the first threshold value, calculating the value of the performance metric based on the set of ground truth measurements and including at least one ground truth measurement of the set for the report.

In some implementations, determining whether to use the set of ground truth measurements to calculate the value of the performance metric may include determining whether the second time difference satisfies a second threshold value, in response to determining that the second time difference satisfies the second threshold value, calculating the value of the performance metric based on the set of ground truth measurements and including at least one ground truth measurement of the set for the report. In some implementations, the second threshold value may be determined based on a capability of a UE.

In some implementations, operations of the method 700 may further include identifying a first configuration of a first periodic CSI report associated with performing the beam prediction, identifying a second configuration of a second periodic CSI report associated with monitoring the performance of the beam prediction, determining the first time instance based on the first configuration, and determining the reference time based on the second configuration. The second periodic CSI report may include the report. In some implementations, the first configuration may include (i) first resource set information associated with the one or more measurements and (ii) a periodicity and an offset of the first periodic CSI report. In some implementations, the second configuration may include (i) second resource set information associated with the set of ground truth measurements, (ii) a periodicity and an offset of the second periodic CSI report, and (iii) a threshold value associated with the first time difference.

In some implementations, the reference time may be determined by one of a start time, an end time, or a median time of a duration of the one or more second time instances.

In some implementations, determining whether to use the set of ground truth measurements to calculate the value of the performance metric may include determining whether the first time difference is smaller than a time difference between a second reference time of another set of ground truth measurements and the first time instance and, in response to determining that the first time difference is smaller than the second time difference, calculating the performance metric based on the set of ground truth measurements.

In some implementations, determining whether to use the set of ground truth measurements to calculate the value of the performance metric may include determining whether the reference time is earlier than a second reference time of another set of ground truth measurements and, in response to determining that the reference time is earlier than the second reference time, calculating the performance metric based on the set of ground truth measurements.

In some implementations, determining whether to use the set of ground truth measurements to calculate the value of the performance metric may include determining whether the reference time is later than a second reference time of another set of ground truth measurements and, in response to determining that the reference time is later than the second reference time, calculating the performance metric based on the set of ground truth measurements.

In some implementations, the performance metric may be calculated based on a plurality of sets of ground truth measurements. The plurality of sets of ground truth measurements may include the set of ground truth measurements.

In some implementations, identifying the set of ground truth measurements for the second set of beams within the reference time may include determining whether the set of ground truth measurements is valid.

In some implementations, determining whether the set of ground truth measurements is valid may include determining whether all ground truth measurements in the set of ground truth measurements are performed and, in response to determining that all ground truth measurements in the set of ground truth measurements are performed, determining that the set of ground truth measurements is valid.

In some implementations, determining whether the set of ground truth measurements is valid may include determining whether at least one ground truth measurement in the set of ground truth measurements is not performed and, in response to determining that the at least one ground truth measurement in the set of ground truth measurements is not performed, determining that the set of ground truth measurements is not valid.

In some implementations, determining whether the set of ground truth measurements is valid may include, for the set of ground truth measurements to be linked to a particular time instance, determining whether a beam inference report associated with the particular time instance is generated, in response to determining that the beam inference report is not generated, determining that the particular time instance is not valid, and, in response to determining that the particular time instance is not valid, determining that the set of ground truth measurements is not valid.

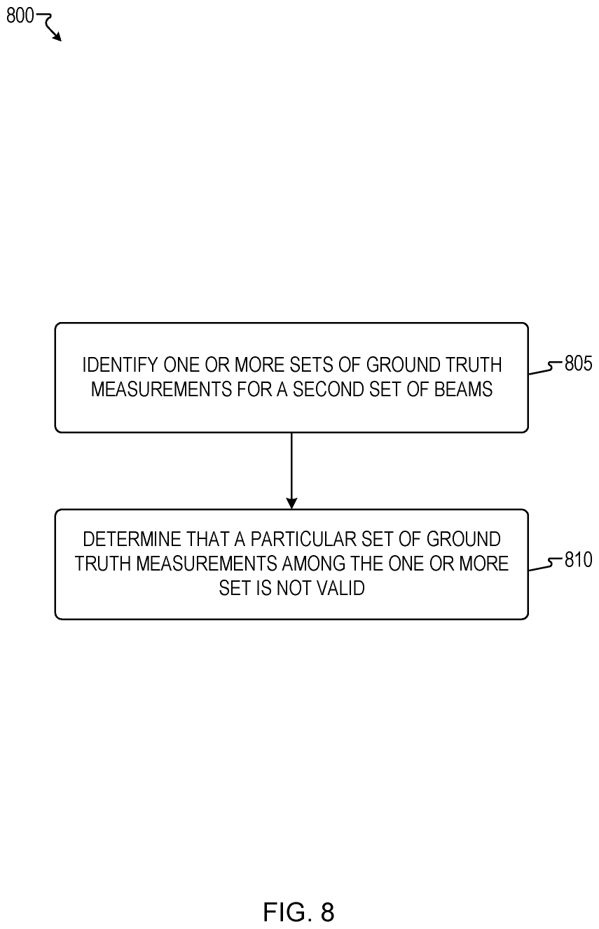

FIG. 8 illustrates a flowchart of an example method 800 for UE-assisted performance monitoring for time-domain downlink beam prediction, according to some implementations. For clarity of presentation, the example method 800 is described in the context of the preceding figures. For clarity of presentation, the example method 800 is described in the context of the preceding figures. For example, the method 800 can be performed by a UE (e.g., the UE 102), or any suitable system, environment, software, hardware, or combination thereof. In some implementations, operations of the method 800 can be run in parallel, in combination, in loops, or in any order. The example method 800 shown in FIG. 8 can be modified or reconfigured to include additional, fewer, or different steps (not shown in FIG. 8), which can be performed in the order shown or in a different order.

Operations of the method 800 include, at 805, identifying one or more sets of ground truth measurements for a second set of beams.

The operation may include identifying one or more time instances for one or more beam predictions inferred from beam measurements of a first set of beams.

Operations of the method 800 include, at 810, determining that a particular set of ground truth measurements among the one or more sets is not valid.

The operation may include determining whether at least one ground truth measurement in the particular set of ground truth measurements is not performed, determining that the particular set of ground truth measurements is not valid based on determining that at least one ground truth measurement in the particular set of ground truth measurements is not performed.

The operation may include, for a particular set of ground truth measurements, determining that an inference report is not generated, determining that the one or more time instances for the one or more beam predictions are not valid based on determining that the inference report is not generated, and determining that the particular set of ground truth measurements is not valid based on determining that one or more time instances for the one or more beam predictions are not valid. The inference report may comprise the one or more beam predictions inferred from the beam measurements of the first set of beams.

For AI/ML-based beam management, consistency between training and inference for UE-side models can be managed. An associated ID may be introduced to handle the consistency between training and inference for UE-side models. In case the UE uses an AI/ML model which is trained with collected training data with an indicated associated ID from a network, and, during a UE exchanges capability and applicability message with the network, the same associated ID is configured for a CSI reporting for AI/ML-based beam prediction along with other parameters, the UE may check the associated ID and other parameters. As such, the UE can determine whether the AI/ML model that the UE uses can provide the needed inference results, and then report back the applicability of the CSI report. In some cases, the network may configure an associated ID for training data collection for the UE side model and/or inference reporting. In such a case, the UE may be able to collect training data and label the training data with a global cell identity (GCI) of the cell from which the training data is collected. The GCI may include information, such as Mobile Country Code (MCC), Mobile Network Code (MNC), Location Area Code (LAC), and Cell Identification (CI). Then, the UE may use the GCI instead of the associated ID for applicability reporting for a CSI reporting configuration by network.

An AI/ML Processing Unit (APU) can be used for AI/ML-based beam management in addition to a CSI processing Unit (CPU) used in the NR networks. In some implementations, one engine dedicated to AI/ML-based beam management and another engine dedicated to AI/ML-based CSI prediction may be used. A use case-specific APU pool (e.g., APU pool for AI/ML-based beam management, APU pool for AI/ML-based CSI prediction) may be defined. Additionally, or alternatively, separate APU pools may be defined, and different AI/ML functionalities (e.g., AI/ML-based beam management, AI/ML-based CSI prediction) may be mapped to one or more APU pools. For UE capability signaling, a UE may report the number of APUs for at least one APU pool (e.g., N_{APu-pool-index}=5, with APU−pool−index=1), and AI/ML functionality mapped to the APU pool. In case the UE does not have enough APUs to update all the CSI reports for inference for one or more AI/ML functionality, the priority rule may be applied on a per APU pool basis. If the required number of APUs to update all CSI reports for inference AI/ML-based beam management exceeds the number of the reported APU for the relevant APU pool (e.g., either dedicated to AI/ML BM or shared with another AI/ML functionality), a existing priority rule may be applied, or the updated Pri_{iCSI}(y, k, c, s) may be used to decide which/what CSI reports for inference for AI/ML-based beam management are updated. Then, a screening procedure may start with the highest priority CSI report for inference for AI/ML-based beam management and accommodate as many CSI reports for inference for AI/ML-based beam management as not to exceed the required number of APUs. In some implementations, a UE may not be expected to be configured with an aperiodic CSI trigger state containing reporting settings for AI/ML-based beam management more than the number given by min (N_(APu−pool−index=1), N_(APu−total)). A UE may not be expected to be configured with an aperiodic CSI trigger state containing reporting settings for AI/ML-based CSI prediction more than the number given by min (N_(APu−pool−index=2), N_(APu−total)). In such implementations, the UE may report N_{APu-pool-index}=1 with capability signaling for AI/ML-based beam management. The UE may report N_{APu-pool-index}=2 with capability signaling for AI/ML-based CSI prediction. The UE may report N_{APu-total} with capability signaling for all AI/ML functionalities.

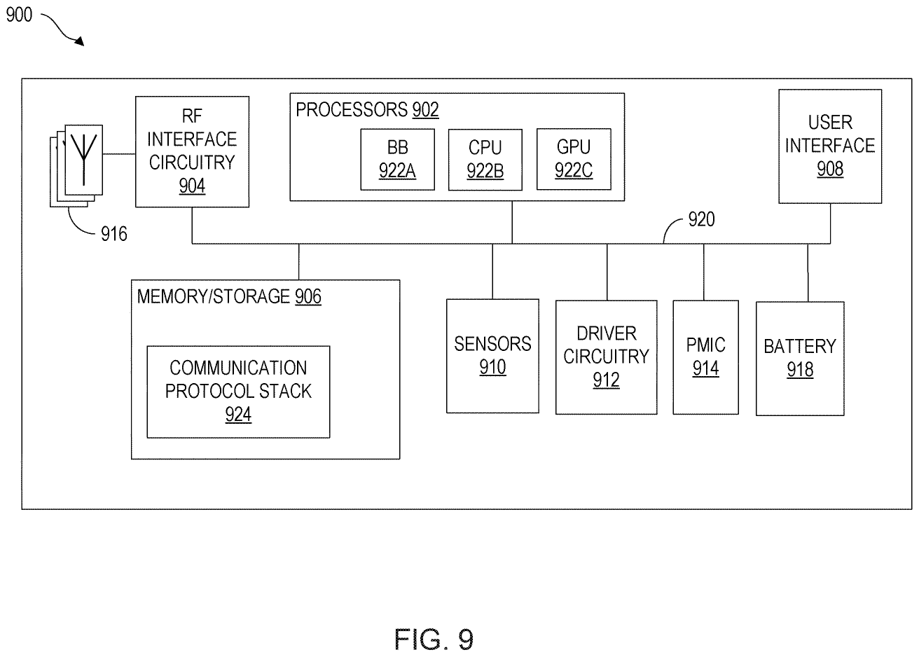

FIG. 9 illustrates an example UE 900, according to some implementations. The UE 900 may be similar to and substantially interchangeable with UE 102 of FIG. 1. The UE 900 may include any mobile or non-mobile computing device, such as, for example, a mobile phone, computer, tablet, industrial wireless sensors, video device (for example, cameras, video cameras, and the like), wearable devices (for example, a smart watch), relaxed internet-of-things (IoT) devices, etc.

The UE 900 may include any/all of processor 902, RF interface circuitry 904, memory/storage 906, user interface 908, sensors 910, driver circuitry 912, power management integrated circuit (PMIC) 914, one or more antenna(s) 916, and battery 918. The components of the UE 900 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 900. However, some of the components shown may be omitted, additional components may be present, and a different arrangement of the components shown may occur in other implementations.

The components of the UE 900 may be coupled with various other components over one or more interconnects 920, which may represent any type of interface, input/output, bus (local, system, or expansion), transmission line, trace, or optical connection that allows various circuit components (on common or different chips or chipsets) to interact with one another.

The processor 902 may include one or more processors. For example, the processor 902 may include processor circuitry such as, for example, baseband (BB) processor circuitry 922A, central processor unit (CPU) circuitry 922B, and graphics processor unit (GPU) circuitry 922C. The processor 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and/or protocol data unit (PDU) layer; and perform control plane functions at a PHY layer, MAC layer, RLC layer, PDCP layer, RRC layer, and/or non-access stratum (NAS) layer. In some implementations, the PHY layer operations may additionally/alternatively be performed by components of the RF interface circuitry 904. The baseband processor circuitry 922A may generate or process baseband signals or waveforms that carry information in 3GPP-compatible networks. In some implementations, waveforms for NR may implement cyclic prefix-orthogonal frequency division multiplexing (CP-OFDM) in the uplink or downlink, and discrete Fourier transform-spread-orthogonal frequency division multiplexing (DFT-S-OFDM) in the uplink.

The memory/storage 906 may include one or more non-transitory, computer-readable media that includes instructions (for example, communication protocol stack 924) that can be executed by the processor 902 to cause the UE 900 to perform various operations described herein. The memory/storage 906 include any type of volatile or non-volatile memory that may be distributed throughout the UE 900. In some implementations, some of the memory/storage 906 may be located on the processor 902 itself (for example, Layer 1 “L1” and Layer 2 “L2” caches), while other memory/storage 906 is external to the processor 902 but accessible thereto via a memory interface. The memory/storage 906 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 904 may include transceiver circuitry and radio frequency front end module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 916 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 916. In various implementations, the RF interface circuitry 904 may be configured to transmit/receive signals in a manner compatible with NR access technologies.

The antenna(s) 916 may include one or more antenna elements to convert electrical signals into radio waves to travel through the air and to convert received radio waves over the air into electrical signals. In some implementations, the antenna elements may be arranged into one or more antenna panels. The antenna(s) 916 may have antenna panels that are omnidirectional, directional, or a combination thereof, to enable beamforming and multiple input, multiple output communications. The antenna(s) 916 may include any/all of microstrip antennas, printed antennas fabricated on the surface of one or more printed circuit boards, patch antennas, phased array antennas, etc. The antenna(s) 916 may have one or more panels designed for one or more specific frequency bands, such as bands in frequency range 1 (FR1) or frequency range 2 (FR2).

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various I/O devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processor 902, the PMIC 914 may control power-source selection, voltage scaling, battery charging, or direct current (DC)-to-DC conversion.

In some implementations, the PMIC 914 may control, or otherwise be part of, various power saving mechanisms of the UE 900. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a lead-acid automotive battery.

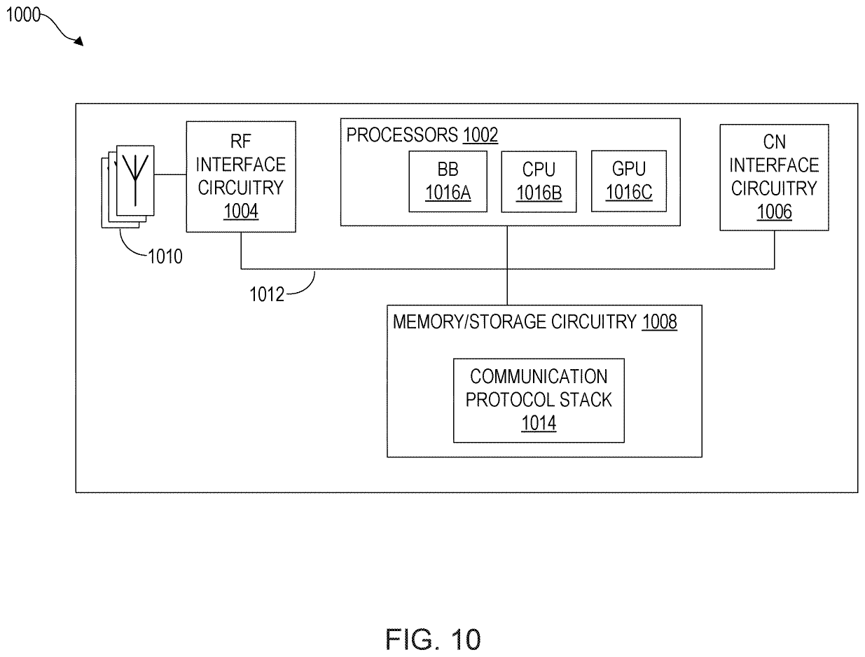

FIG. 10 illustrates an example access node 1000 (e.g., a base station or gNB), according to some implementations. The access node 1000 may be similar to and substantially interchangeable with base station 104. The access node 1000 may include one or more of processor 1002, RF interface circuitry 1004, core network (CN) interface circuitry 1006, memory/storage circuitry 1008, and one or more antenna(s) 1010. The processor 1002 may include any type of circuitry or processor circuitry that executes or otherwise operates computer-executable instructions, such as program code, software modules, or functional processes from memory/storage circuitry 1008 to cause the access node 1000 to perform operations as described herein.

The components of the access node 1000 may be coupled with various other components over one or more interconnects 1012. The processor 1002, RF interface circuitry 1004, memory/storage circuitry 1008 (including communication protocol stack 1014), antenna(s) 1010, and interconnects 1012 may be similar to like-named elements shown and described with respect to FIG. 9. For example, the processor 1002 may include processor circuitry such as, for example, BB processor circuitry 1016A, CPU circuitry 1016B, and GPU circuitry 1016C.

The CN interface circuitry 1006 may provide connectivity to a core network, for example, a 5G core (5GC) network using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or field-programmable gate arrays (FPGA) to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as base stations, gNBs, RAN nodes, eNBs, NodeBs, roadside units (RSU), transmit-receive points (TRP), and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a cloud radio access network (CRAN) and/or a virtual baseband unit pool (vBBUP). In vehicle-to-everything (V2X) scenarios, the access node 1000 may be or act as an RSU. The term RSU refers to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, or the like, as described above in connection with one or more of the preceding figures may be configured to operate in accordance with one or more of the examples set forth below.

Example 1 is a method including: determining a first time instance for a beam prediction inferred from beam measurements of a first set of beams, identifying a valid set of ground truth measurements for a second set of beams within one or more second time instances, where the one or more second time instances is associated with the first time instance, calculating, based on the valid set of ground truth measurements, a value of a performance metric representing a performance of the beam prediction of the first time instance, and causing transmission of a report indicating the value of the performance metric.

Example 2 includes the method of example 1, where identifying the valid set of ground truth measurements for the second set of beams within the one or more second time instances comprises determining whether all ground truth measurements in a particular set of ground truth measurements are performed and, based on determining that all ground truth measurements in the particular set of ground truth measurements are performed, determining that the particular set of ground truth measurements is valid.

Example 3 includes the method of example 1, further including determining whether a first timing gap between a timing of the one or more second time instances and a timing of the first time instance is smaller than a second timing gap between a timing of another set of ground truth measurements and the timing of the first time instance and, based on determining that the first timing gap is smaller than the second timing gap, determining that the one or more second time instances are associated with the first time instance.

Example 4 includes the method of example 1, further including determining whether a first timing of the one or more second time instances is earlier than a second timing of another set of ground truth measurements and, based on determining that the first timing is earlier than the second timing, determining that the one or more second time instances are associated with the first time instance.

Example 5 includes the method of example 1, further including determining whether a first timing of the one or more second time instances is later than a second timing of another set of ground truth measurements and, based on determining that the first timing is later than the second timing, determining that the one or more second time instances are associated with the first time instance.

Example 6 includes the method of example 1, where causing the transmission of the report indicating the value of the performance metric comprises determining whether a timing gap between a first time associated with an inference report and a second time of the one or more second time instances satisfies a threshold value, where the inference report comprises one or more beam predictions inferred from beam measurements of the first set of beams, and, based on determining that the timing gap satisfies the threshold value, logging a sample for the first time associated with the inference report.

Example 7 includes the method of example 6, where the timing gap is a smallest among a set of timing gaps, and each timing gap is between the first time associated with the inference report and a respective time instance for a set of ground truth measurements.

Example 8 includes the method of example 6, where the threshold value is determined based on a capability of a UE.

Example 9 includes the method of example 1, where causing the transmission of the report indicating the value of the performance metric comprises determining whether a timing gap between a first time of the one or more second time instances and a second time of the first time instance satisfies a threshold value and, based on determining that the timing gap satisfies the threshold value, logging a sample for the time instance for an inference report.

Example 10 includes the method of example 9, where timing gap is smallest among timing gaps, and each timing gap is between the first time of the one or more second time instances and the respective time instance for a beam prediction.

Example 11 includes the method of example 9, where the timing of the first time instance is earlier than a timing of another time instance for beam prediction.

Example 12 includes the method of example 1, further including identifying a first configuration of a first periodic CSI report associated with the beam prediction, identifying a second configuration of a second periodic CSI report associated with monitoring the performance of the beam prediction, determining a timing of the first time instance based on the first configuration, and determining a timing of the one or more second time instances based on the second configuration.

Example 13 includes the method of example 12, where the timing of the one or more second time instances is determined by one of a start time, an end time, or a median time of a duration of the one or more second time instances.

Example 14 includes the method of example 12, further including identifying a threshold value between a timing of the first time instance and a timing of the one or more second time instances based on the second configuration.

Example 15 includes the method of example 12, where the first configuration comprises information associated with a first resource set for the measurements for the first set of beams and information associated with a periodicity and an offset of the first periodic CSI report associated with the beam prediction.

Example 16 includes the method of example 12, where the second configuration comprises information associated with a second resource set for the set of ground truth measurements for the second set of beams, information associated with a periodicity and an offset of the second periodic CSI report associated with monitoring the performance of the beam prediction, and a threshold value between a timing of the first time instance and a timing of the one or more second time instances.

Example 17 includes the method of example 1, where the first time instance is associated with more than one time instance of more than one set of ground truth measurements.

Example 18 is a method including: identifying one or more sets of ground truth measurements for a second set of beams and determining that a particular set of ground truth measurements among the one or more sets is not valid.

Example 19 includes the method of example 18, where determining that the particular set of ground truth measurements among the one or more sets is not valid comprises determining whether at least one ground truth measurement in the particular set of ground truth measurements is not performed and, based on determining that at least one ground truth measurement in the particular set of ground truth measurements is not performed, determining that the particular set of ground truth measurements is not valid.

Example 20 includes the method of example 18, where determining that the particular set of ground truth measurements among the one or more sets is not valid comprises identifying one or more time instances for one or more beam predictions inferred from beam measurements of a first set of beams, for a particular set of ground truth measurements, determining that an inference report is not generated, where the inference report comprises the one or more beam predictions inferred from the beam measurements of the first set of beams, based on determining that the inference report is not generated, determining that the one or more time instances for the one or more beam predictions are not valid, and, based on determining that one or more time instances for the one or more beam predictions are not valid, determining that the particular set of ground truth measurements is not valid.

Example 21 is one or more processors configured to, when executing instructions stored in memory, perform the method of any of examples 1 to 20.

Example 22 is a non-transitory computer storage medium encoded with instructions that, when executed by one or more processors, cause the one or more processors to perform the method of any of examples 1 to 20.

Example 23 is a system comprising one or more processors and one or more storage devices on which are stored instructions that are operable, when executed by the one or more processors, to cause the one or more processors to perform the method of any of examples 1 to 20.

Example 24 is an apparatus comprising one or more baseband processors configured to perform the method of any of examples 1 to 20.

Example 25 is a method including: performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

Example 26 includes the method of example 25, where determining whether to use the set of ground truth measurements to calculate the value of the performance metric includes determining whether the first time difference satisfies a first threshold value, in response to determining that the first time difference satisfies the first threshold value, calculating the value of the performance metric based on the set of ground truth measurements and including at least one ground truth measurement of the set for the report.

Example 27 includes the method of example 25, where determining whether to use the set of ground truth measurements to calculate the value of the performance metric includes determining whether the second time difference satisfies a second threshold value, in response to determining that the second time difference satisfies the second threshold value, calculating the value of the performance metric based on the set of ground truth measurements and including at least one ground truth measurement of the set for the report.

Example 28 includes the method of example 27, where the second threshold value is determined based on a capability of a UE.

Example 29 includes the method of example 25, further including identifying a first configuration of a first periodic CSI report associated with performing the beam prediction, identifying a second configuration of a second periodic CSI report associated with monitoring the performance of the beam prediction, where the second periodic CSI report includes the report, determining the first time instance based on the first configuration, and determining the reference time based on the second configuration.

Example 30 includes the method of example 29, where the first configuration includes (i) first resource set information associated with the one or more measurements and (ii) a periodicity and an offset of the first periodic CSI report.

Example 31 includes the method of example 29, where the second configuration includes (i) second resource set information associated with the set of ground truth measurements, (ii) a periodicity and an offset of the second periodic CSI report, and (iii) a threshold value associated with the first time difference.

Example 32 includes the method of example 25, where the reference time is determined by one of a start time, an end time, or a median time of a duration of the one or more second time instances.

Example 33 includes the method of example 25, where determining whether to use the set of ground truth measurements to calculate the value of the performance metric includes determining whether the first time difference is smaller than a time difference between a second reference time of another set of ground truth measurements and the first time instance and, in response to determining that the first time difference is smaller than the second time difference, calculating the performance metric based on the set of ground truth measurements.

Example 34 includes the method of example 25, where determining whether to use the set of ground truth measurements to calculate the value of the performance metric includes determining whether the reference time is earlier than a second reference time of another set of ground truth measurements and, in response to determining that the reference time is earlier than the second reference time, calculating the performance metric based on the set of ground truth measurements.

Example 35 includes the method of example 25, where determining whether to use the set of ground truth measurements to calculate the value of the performance metric includes determining whether the reference time is later than a second reference time of another set of ground truth measurements and, in response to determining that the reference time is later than the second reference time, calculating the performance metric based on the set of ground truth measurements.

Example 36 includes the method of example 25, where the performance metric is calculated based on a plurality of sets of ground truth measurements, where the plurality of sets of ground truth measurements includes the set of ground truth measurements.

Example 37 includes the method of example 25, where identifying the set of ground truth measurements for the second set of beams within the reference time includes determining whether the set of ground truth measurements is valid.

Example 38 includes the method of example 37, where determining whether the set of ground truth measurements is valid includes determining whether all ground truth measurements in the set of ground truth measurements are performed and, in response to determining that all ground truth measurements in the set of ground truth measurements are performed, determining that the set of ground truth measurements is valid.

Example 39 includes the method of example 37, where determining whether the set of ground truth measurements is valid includes determining whether at least one ground truth measurement in the set of ground truth measurements is not performed and, in response to determining that the at least one ground truth measurement in the set of ground truth measurements is not performed, determining that the set of ground truth measurements is not valid.

Example 40 includes the method of example 37, where determining whether the set of ground truth measurements is valid includes, for the set of ground truth measurements to be linked to a particular time instance, determining whether a beam inference report associated with the particular time instance is generated, in response to determining that the beam inference report is not generated, determining that the particular time instance is not valid, and, in response to determining that the particular time instance is not valid, determining that the set of ground truth measurements is not valid.

Example 41 is an apparatus including memory and one or more processors coupled to the memory and configured to, when executing instructions stored in the memory, cause the apparatus to perform operations, the operations including: performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

Example 42 includes the apparatus of example 41, where determining whether to use the set of ground truth measurements to calculate the value of the performance metric includes determining whether the first time difference satisfies a first threshold value, in response to determining that the first time difference satisfies the first threshold value, calculating the value of the performance metric based on the set of ground truth measurements and including at least one ground truth measurement of the set for the report.

Example 43 includes the apparatus of example 41, where determining whether to use the set of ground truth measurements to calculate the value of the performance metric includes determining whether the second time difference satisfies a second threshold value, in response to determining that the second time difference satisfies the second threshold value, calculating the value of the performance metric based on the set of ground truth measurements and including at least one ground truth measurement of the set for the report.

Example 44 is a baseband processor configured to, when executing instructions stored in a memory, perform operations, the operations including performing, based on one or more measurements of a first set of beams, a beam prediction for a first time instance, identifying a set of ground truth measurements for a second set of beams associated with a reference time, determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report, and causing transmission of the report indicating the value of the performance metric.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the beam prediction processes can be used to benefit users.

For example, the data can be used to train models that can be deployed to improve performance, accuracy, and/or functionality of applications and/or services. Accordingly, the use of the data enables the beam prediction processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the beam prediction processes are also contemplated by the present disclosure.

The present disclosure contemplates that, in some embodiments, data used by beam prediction processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with beam prediction processes, should attempt to comply with well-established privacy policies and/or privacy practices.

Any of the foregoing examples can be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For example, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For example, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. A method comprising:
performing, based on one or more measurements of a first set of beams, a beam prediction for a first time instance;
identifying a set of ground truth measurements for a second set of beams associated with a reference time;
determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report; and
causing transmission of the report indicating the value of the performance metric.

2. The method of claim 1, wherein determining whether to use the set of ground truth measurements to calculate the value of the performance metric comprises:
determining whether the first time difference satisfies a first threshold value;
in response to determining that the first time difference satisfies the first threshold value:
calculating the value of the performance metric based on the set of ground truth measurements; and
including at least one ground truth measurement of the set for the report.

3. The method of claim 1, wherein determining whether to use the set of ground truth measurements to calculate the value of the performance metric comprises:
determining whether the second time difference satisfies a second threshold value;
in response to determining that the second time difference satisfies the second threshold value:
calculating the value of the performance metric based on the set of ground truth measurements; and
including at least one ground truth measurement of the set for the report.

4. The method of claim 3, wherein the second threshold value is determined based on a capability of a user equipment (UE).

5. The method of claim 1, the method further comprising:
identifying a first configuration of a first periodic channel state information (CSI) report associated with performing the beam prediction;
identifying a second configuration of a second periodic CSI report associated with monitoring the performance of the beam prediction, the second periodic CSI report comprising the report;
determining the first time instance based on the first configuration; and
determining the reference time based on the second configuration.

6. The method of claim 5, wherein the first configuration comprises (i) first resource set information associated with the one or more measurements and (ii) a periodicity and an offset of the first periodic CSI report.

7. The method of claim 5, wherein the second configuration comprises (i) second resource set information associated with the set of ground truth measurements, (ii) a periodicity and an offset of the second periodic CSI report, and (iii) a threshold value associated with the first time difference.

8. The method of claim 1, wherein the reference time is determined by one of a start time, an end time, or a median time of a duration of the one or more second time instances.

9. The method of claim 1, wherein determining whether to use the set of ground truth measurements to calculate the value of the performance metric comprises:
determining whether the first time difference is smaller than a time difference between a second reference time of another set of ground truth measurements and the first time instance; and
in response to determining that the first time difference is smaller than the second time difference, calculating the performance metric based on the set of ground truth measurements.

10. The method of claim 1, wherein determining whether to use the set of ground truth measurements to calculate the value of the performance metric comprises:
determining whether the reference time is earlier than a second reference time of another set of ground truth measurements; and
in response to determining that the reference time is earlier than the second reference time, calculating the performance metric based on the set of ground truth measurements.

11. The method of claim 1, wherein determining whether to use the set of ground truth measurements to calculate the value of the performance metric comprises:
determining whether the reference time is later than a second reference time of another set of ground truth measurements; and
in response to determining that the reference time is later than the second reference time, calculating the performance metric based on the set of ground truth measurements.

12. The method of claim 1, wherein the performance metric is calculated based on a plurality of sets of ground truth measurements, the plurality of sets of ground truth measurements comprising the set of ground truth measurements.

13. The method of claim 1, wherein identifying the set of ground truth measurements for the second set of beams within the reference time comprises:
determining whether the set of ground truth measurements is valid.

14. The method of claim 13, wherein determining whether the set of ground truth measurements is valid comprises:
determining whether all ground truth measurements in the set of ground truth measurements are performed; and
in response to determining that all ground truth measurements in the set of ground truth measurements are performed, determining that the set of ground truth measurements is valid.

15. The method of claim 13, wherein determining whether the set of ground truth measurements is valid comprises:
determining whether at least one ground truth measurement in the set of ground truth measurements is not performed; and
in response to determining that the at least one ground truth measurement in the set of ground truth measurements is not performed, determining that the set of ground truth measurements is not valid.

16. The method of claim 13, wherein determining whether the set of ground truth measurements is valid comprises:
for the set of ground truth measurements to be linked to a particular time instance:
determining whether a beam inference report associated with the particular time instance is generated;
in response to determining that the beam inference report is not generated, determining that the particular time instance is not valid; and
in response to determining that the particular time instance is not valid, determining that the set of ground truth measurements is not valid.

17. An apparatus comprising:
memory; and
one or more processors coupled to the memory and configured to, when executing instructions stored in the memory, cause the apparatus to perform operations, the operations comprising:
performing, based on one or more measurements of a first set of beams, a beam prediction for a first time instance;
identifying a set of ground truth measurements for a second set of beams associated with a reference time;
determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report; and
causing transmission of the report indicating the value of the performance metric.

18. The apparatus of claim 17, wherein determining whether to use the set of ground truth measurements to calculate the value of the performance metric comprises:
determining whether the first time difference satisfies a first threshold value;
in response to determining that the first time difference satisfies the first threshold value:
calculating the value of the performance metric based on the set of ground truth measurements; and
including at least one ground truth measurement of the set for the report.

19. The apparatus of claim 17, wherein determining whether to use the set of ground truth measurements to calculate the value of the performance metric comprises:
determining whether the second time difference satisfies a second threshold value;
in response to determining that the second time difference satisfies the second threshold value:
calculating the value of the performance metric based on the set of ground truth measurements; and
including at least one ground truth measurement of the set for the report.

20. A baseband processor configured to, when executing instructions stored in a memory, perform operations, the operations comprising:
performing, based on one or more measurements of a first set of beams, a beam prediction for a first time instance;
identifying a set of ground truth measurements for a second set of beams associated with a reference time;
determining whether to use the set of ground truth measurements to calculate a value of a performance metric that represents accuracy of the beam prediction, the determining based on at least one of (i) a first time difference between the reference time and the first time instance or (ii) a second time difference between the reference time and a second time instance for a report; and
causing transmission of the report indicating the value of the performance metric.
